(19) United States
(12) Patent Application Publication
(10) Pub. No.: US 2004/0247863 A1
(43) Pub. Date: Dec. 9, 2004

(54) Label

(76) Inventor: Leonard James Scott, Victoria (AU)

Correspondence Address: BAKER & BOTTS, 30 ROCKEFELLER PLAZA, NEW YORK, NY, 10112

(21) Appl. No.: 10/796,889

(22) Filed: Mar. 9, 2004

Related U.S. Application Data
(63) Continuation-in-part of application No. 09/720,691, filed on Dec. 28, 2000, now Pat. No. 6,733,855.
Application No. 09/720,691 is a 371 of international application No. PCT/AU99/00681, filed on Aug. 24, 1999.

(30) Foreign Application Priority Data
Sep. 24, 1998 (AU) PP6135/98
Aug. 2, 1999 (AU) 42420/99

(51) Int. Cl. B32B 7/12; B32B 9/00

(52) U.S. Cl. 428/343; 428/354

(57) ABSTRACT

A composite label including a first layer adapted to display an image at a first major surface of the label and a second layer adapted to display an image at a second major surface of the label, the second layer including a removable portion adapted to be removed from the label and secured to another object, and wherein the first and second layers are formed of materials that are selected such that the second layer may be cut or scored so as to define the removable portion, without compromising the integrity of the first layer.

### CROSS-REFERENCE TO RELATED APPLICATIONS

This application is a Continuation-in-part (CIP) of U.S. patent application Ser. No. 09/720,691, filed Dec. 28, 2000, which is a national stage application under 35 U.S.C. §371 of International Patent Application PCT/AU99/00681 filed Aug. 24, 1999, both of which are incorporated by reference in their entirety herein and which claim priority to Australian Patent Application Nos. PP6135/98 filed Sep. 24, 1998 and 42420/99 filed Aug. 2, 1999.

### FIELD OF THE INVENTION

The present invention relates to the field of labels, particularly labels with removable promotional or advertising material.

### BACKGROUND OF THE INVENTION

The broad concept of providing labels with removable adhesive stickers is known. For example, International Patent Application No. PCT/US97/18837 discloses a label with an adhesive sticker arranged on an inside face of the label. Such a label is, however, known to be formed of a simple double layer construction of conventional laminated paper or polypropylene material which is considered to be cost effective and sufficiently robust for use with tinned produce or the like. There has not been any suitable application of such a label to the soft drink industry where material thickness and reliable application of the label is of paramount concern.

The object of the present invention is to provide a label construction which is particularly, but not exclusively, suitable for use in a commercial bottle labeling installation and more specifically it is an object to provide a label which is readily adapted to be cut and wrapped about a bottle for proper application during bottle manipulation.

### SUMMARY OF THE INVENTION

In accordance with a first aspect of the invention, there is provided a composite label including a first layer adapted to display an image at a first major surface of the label and a second layer adapted to display an image at a second major surface of the label, the second layer including a removable portion adapted to be removed from the label and secured to another object, and wherein the first and second layers are formed of materials that are selected such that the second layer may be cut or scored so as to define the removable portion, without compromising the integrity of the first layer.

The selection of materials from which the first and second layers of the label are formed is an important feature of this invention. As will be explained below, the first and second layers may be required to exhibit a number of characteristics and materials useful for forming the first and second layers may be chosen accordingly.

An important element of the invention relates to the selection of materials for forming the first and second layers so that the second layer may be cut or scored, in order to define the removable portion of the label, without compromising the integrity of the first layer. It will be appreciated that the removable portion is actually a portion of the second layer defined by a perimeter/boundary which may be cut or scored into the second layer. The removable portion may be removed from the label with relative ease and, in order for this to be possible, when the second layer is cut or scored it is important that the first layer is not substantially penetrated. If substantial penetration occurs, as well as being unsightly, it may be difficult to detach the removable portion from the label. Preferably, the materials of the first and second layers are selected so that, when the second layer is cut or scored to define the removable portion, the effect of this is not noticeable or obviously visible at the surface of the label remote from the second layer, i.e., at the first major surface of the label. Any markings (protrusions) on the first major surface as a result of the process used to define the removable portion may detract from the aesthetic appearance of the first major surface of the label.

In accordance with this aspect of the invention, in order to preserve the integrity of the first layer, the material from which the first layer is formed has greater hardness than the material from which the second layer is formed. In this context, the term “hardness” is intended to reflect the fact that the material of the first layer is more resistant to cutting or scoring than the material of the second layer. Put another way, the material from which the first layer is formed has a softness less than the material from which the second layer is formed. The relative cut/score resistance of the materials chosen for the first and second layers may be related to their density. In one embodiment, the second layer is formed of a material having a density less than that of the material from which the first layer is formed.

Typically, the first layer is provided as a thin film formed from a single material having the required hardness throughout its thickness. However, the first layer may only exhibit the required hardness in a region thereof adjacent the interface between the first and second layers. This brings with it the possibility of the first layer being a composite layer of two or more different materials, the layer thereof that will be located at the interface between the first and second layers being selected in order to ensure that the integrity of the first layer (as a whole) is not compromised. In the following discussion, unless context dictates otherwise, reference to the hardness of the material of the first layer should also be understood as meaning the surface hardness of a composite first layer at the surface of the composite layer to be provided adjacent the second layer.

The materials used for forming the first and second layers are usually polymers. The glass transition temperature and/or crystallinity may provide a useful guide to the likely relative hardness of polymeric materials. For example, highly ordered crystalline polymers are likely to be harder than amorphous polymers.

In practice, selection of the materials for the first and second layers may be influenced to a significant extent by the technique used to define the removable portion by cutting or scoring of the second layer. Here a variety of techniques may be used such as rotary cutting, stamping, rotary scoring, and the like. Such techniques are well known in the art. It perhaps goes without saying that the material of the second layer must be sufficiently soft to facilitate cutting or scoring by the chosen technique and associated operating parameters. Similarly, the material of the first layer will be selected so that its integrity will not be compromised by the cutting or scoring operation. Here it will also be necessary to take into account the depth tolerance in cut or score that may be achieved in practice using a given piece of equipment. For example, when using a cutting technique and equipment that has a depth tolerance of ±10 μm, it will be necessary to use a material for the first layer which is relatively more hard than when cutting equipment with a depth tolerance of ±3 μm is used. The thickness of the first layer will also be determined with this in mind. Likewise, when selecting materials for the first and second layers, it may also be necessary to take into account changes in equipment operation parameters as might be required between runs or equipment services. Thus, the materials chosen for the first and second layers may need to be selected taking into account that the cutting or scoring efficiency may deteriorate over time. This is likely to occur when cutting or scoring tools become blunt.

The materials chosen for the first and second layers should also be selected based on the intended use of the label. Thus, when the label is to be used on a drink bottle, it must be relatively thin and sufficiently flexible to be wrapped around the bottle. If the material of the first and/or second layers has poor mechanical strength and low flexibility, the label is unlikely to be useful in this respect.

It is an important feature of the invention that the first and second layers are adapted to display an image and this may also influence the choice of materials used for the first and second layers. Typically, the image will include written information, such as instructions or advertising literature, or graphics, artwork, and the like, or a combination of such. The image may even simply involve colour of particular significance to the intended use of the label.

Usually, the image will be applied to the first and second layers by printing techniques commonly used in the art. The first and second layers will be printed with the images to be displayed at the first and second major surfaces, respectively. These surfaces are usually opposing sides of the label. In this case it will be required that the material for the first and second layers is printable per se, or that the surface of the material may be processed in order to render it printable. This may involve direct treatment of the surface of the material or application of some compatible ink receptive coating which is receptive to being printed upon.

In accordance with this aspect of the invention, the first and second layers of the label are usually printed with an image as the label is manufactured. If necessary, after printing, a transparent coating may be applied to improve appearance and/or image permanence. The result is a ready to use label. However, it is possible that the label is manufactured without any image provided on the first and/or second layers. In this case the label may be processed subsequently in order to provide (e.g., print) an image on the blank layers(s), as necessary.

In the label in accordance with the invention the first and second layers are bonded to each other with an adhesive. The adhesive may be a pressure sensitive adhesive. Conventional adhesives may be used in this respect. Typically, the adhesive is a rubber/resin, acrylate, hot-melt or solvent-based adhesive. To enable the removable portion to be removed and secured to another object, the adhesive must have a greater adhesive affinity for the second layer than it does for the first layer. This means that when the removable portion is removed from the (second layer of the) label, it retains the adhesive and this allows the removable portion to be secured to another object. Depending upon the materials selected for the first and second layer, it may be necessary to use a release agent/coating on the first layer in order to ensure that the adhesive used has greater adhesive affinity for the second layer. Conventional release coatings may be used, such as silicone-based release coatings. The adhesive and a release coating (if used), should facilitate removal of the removable portion of the label such that the release (peel) strength is from 17 grams force/50 mm to 30 grams force/50 mm. Peel strength may be determined in a conventional manner.

The relative thicknesses of the first and second layers may vary depending upon, amongst other things, the hardness of the materials from which the layers are formed. For instance, if the material of the first layer is relatively hard, it may be possible to use a very thin layer of material in order to obtain the desired results in accordance with the present invention. On the other hand, when the material is less hard, it may be necessary to increase the layer thickness in order to avoid the integrity of the first layer being compromised during formation of the removable portion.

Preferably, at the thickness used, the first layer should also be opaque to the extent that any image displayed at the second major surface of the label is not visible at the first major surface through the first layer. Typically, the first layer has an opacity of 80%. If necessary, this may be achieved by use of conventional additives, although care must be taken to ensure that such additives do not adversely effect the properties required of the first layer (hardness etc.). Alternatively, the first layer may be transparent so that an image printed on the second layer is viewable from the first major surface of the label.

Usually, the label of the invention is manufactured by laminating first and second layers together using an adhesive which may be applied to the second layer. Prior to lamination the relevant surface of one or both layers may be coated with an ink receptive coating, as might be necessary to render the surface(s) printable. The first coating may also be provided with a layer of a release agent on the surface thereof that will be in contact with the adhesive when lamination takes place. After the first and second layers have been laminated together, the removable portion is defined in the second layer by cutting or scoring thereof. Printing of an image on the relevant surfaces of the first and second layers may take place before or after formation of the removable portion. Alternatively, the relevant surfaces may be left blank for subsequent application of an image.

The total thickness of the label should be as low as possible while maintaining the desired physical properties relevant to the intended use of the label. Typically, the label will be applied to an article, such as a soft drinks bottle, using automated equipment, and a label used for this application must be sufficiently robust to be applied by such means. Usually, the label thickness will be from 50 to 150 μm, more typically from 60 to 140 μm. Usually, the thickness of the first and second layers will be as low as possible without detriment to the properties and characteristics required of these layers.

Materials suitable for formation of the first and second layers may be selected from: polyolefins, such as polyethylene (PE) and polypropylene (PP); polyesters, such as polyethylene terephthalate (PET); nylons; and vinylidene polymers, such as polyvinylidene chloride (PVdC) and polyvinylchloride (PVC). Typically, the first and second layers are formed from materials selected from different classes of polymer. For instance, the first layer may be formed from PET and the second layer from PP. The various factors influencing the choice of materials will of course be taken into account when selecting materials for the first and second layers.

The material used for the first and/or second layer may be a homopolymer or copolymer. Examples of copolymers include copolymers of LLDPE or metallocene PE with ethylene vinyl acetate (EVA).

It may be possible to manipulate the properties of a polymer in order to render it suitable for use as the first layer in accordance with the present invention. For instance, it may be possible to enhance the hardness of a polymeric film by manipulation of the polymer composition and/or by the way in which the film is formed and/or subsequently processed. Thus, it may be possible to achieve the desired properties in the first layer by varying the polymer formulation or by techniques such as polishing, casting, stenting, pearlising, metallizing and the like. One skilled in the art would understand how such techniques are to be performed as well as the likely effect on film properties.

The following list includes a more comprehensive, exemplary list of the type of films that may be used for the first and/or second layers of the labels of the present invention.

Polyoefins

PE film

High density PE film

PP film

Oriented PP film

Cast PP film

Biaxially orientated PP (BOPP) film (density 0.7-0.9 g/cm³)

Pearlised PP film

Metallised PP film

High density PP blended film (density 0.8-1.2 g/cm³)

Polyesters

PET film

Metallised PET film

Nylons

Cast nylon

Biaxial nylon

Vinyl Chlorides

Biaxially oriented PVdC film

PVC film

Cast PVC film

Calendered PVC film

As noted earlier, the first layer may be a composite formed from two or more materials. For instance, it may be possible to enhance the surface hardness of a PP film by providing on the surface thereof a layer of PET. The same effect may be achieved by coating the PP film with an acrylic coating and/or a PVdC coating. Other examples of this kind of approach include a layer comprising a metallised polyester core laminated between two layers of PVdC coated cellulose.

By way of illustration it has been found that forming the first layer from a polyester, such as PET, or from high density PP (with density about 1.14 g/cm³) can yield a first layer with satisfactory properties. The first layer may also be a composite layer formed of PP with a surface coating of PET, the latter enhancing the surface hardness of the PP. The material of the second layer may be selected by reference to the properties of this first layer bearing in mind the various other considerations outlined herein. For the examples of first layers given, the second layer may be a BOPP film. In this case the surfaces of the first and second layers, corresponding respectively to the first and second major surfaces of the label, will typically be coated with an ink receptive coating in order to render the surfaces suitable for printing upon.

By way of more detailed illustration, the first layer may be formed of PET or HDPP or be a composite HDPP/PET film. The first layer has a thickness of 20-35 μm. To one side of this layer is applied an ink receptive coating (usually 1-8 μm) and on the other side a silicone release coating (usually 1-8 μm). The second layer may be formed of a BOPP film (density 0.7 -0.9 g/cm³) having a thickness of 25-35 μm. To one side of this film is applied an adhesive (usually 13-25 μm) and on the other side an ink receptive coating (usually 1-8 μm). A laminate of the layers is then formed, with the adhesive of the second layer being brought into contact with the release coating provided on the first layer. The overall thickness of the laminate (label) will be from about 60-120 μm. The removable portion may be defined in the second layer using a rotary cutter. If required, images may be formed on the ink receptive coatings (before or after formation of the removable portion) by conventional printing techniques. Once formed the laminate label preferably has a burst strength of 7-28 kg.

In accordance with another aspect of the invention, there is provided a composite label including a first layer of printed polyester for displaying information at a first major surface of the label and a second layer including material having a density less than the polyester for presenting information at a second major surface of the label, the second layer including a removable portion arranged to be separated from the label and secured to another object.

Polyester has previously been used as a clear laminate for labels but has not, to the Applicant's knowledge, ever been used as an information carrying surface in a composite label. According to an exemplary embodiment, the label uses a white polyester which is chemically treated for penetration and acceptance of ink. The material of the second layer of this embodiment comprises polypropylene. The polyester provides a number of advantages due to its comparative density relative to the polypropylene. For example, the depth dimension of the label may be minimized while a suitable degree of strength is maintained in the label and the polypropylene may be readily cut or scored due to its relative softness, so as to define the removable portion, without compromising the integrity of the polyester layer.

Preferably, the second layer includes an adhesive on one side thereof for securing the removable portion to the first layer and the first layer includes a release coating to facilitate removal of the portion therefrom, the adhesive and release coating providing a release strength factor of between 17 grams force/50 mm and 30 grams force/50 mm.

Such a release strength factor represents the result of a considerable amount of research into application of a composite label to the bottling industry. The release strength factor prevents accidental “fly-offs” or separation of the first and second layers during high speed labelling, while still allowing a user to peel off the removable portion with relative ease.

Accordingly, another broad aspect of the invention relates to the release strength factor and provides a composite label including a first layer for displaying information at a first major surface of the label and a second layer including a removable portion arranged to be separated from the label and secured to another object, wherein the second layer includes an adhesive on one side thereof for securing the removable portion to the first layer and the first layer includes a release coating to facilitate removal of the portion therefrom, the adhesive and release coating providing a release strength factor of between 17 grams force/50 mm and 30 grams force/50 mm.

The first and second layers may then be formed as described above but, alternatively, the second layer may instead be printed with information for display to both sides thereof and the first layer may be transparent such that the information printed on the second layer is viewable from the first major surface of the label.

In that regard, the second layer may also be a transparent material, such as clear polypropylene, with a plurality of overlaid print layers applied thereto comprising a first image printed on the transparent material, for display toward the first major surface, a masking layer and a second image facing outwardly of the second major surface.

Preferably, the release coating is formed of a silicone material or epoxy resin, or release additive.

Preferably, a clear polypropylene laminate is applied on the first major surface. Preferably a varnish is applied to the second major surface with a coefficient of friction in the range of about 0.25 to 0.40.

Preferably, a depth dimension of the first layer is in the range of about 12 micron to 36 micron. Preferably, the second layer has a depth dimension in the range of about 23 micron to 36 micron.

Preferably, the second layer includes a mark for detection by an electronic eye to facilitate actuation of a cutting device, for scoring the second layer so as to define the removable portion. Preferably the portion is in the form of a sticker.

Preferably, the label is for use with a bottle and includes an aggressive adhesive applied to the second major surface in a region adjacent the removable portion, to facilitate secure attachment of the label to the bottle.

### BRIEF DESCRIPTION OF THE DRAWINGS

The invention is more fully described, by way of non-limiting example only, with reference to the accompanying drawings, in which:

FIG. 1 is a perspective view of a label in accordance with the invention;

FIG. 2 is a perspective view of a bottle with the label affixed thereto;

FIG. 3 is a perspective view of the bottle of FIG. 2 with the label partially removed;

FIG. 4 is a schematic flow chart illustrating the manufacturing steps for producing the label;

FIG. 5a is a diagrammatic plan view of the label of the invention;

FIG. 5b is a diagrammatic exploded cross-section view of the label of FIG. 5a;

FIG. 6 is a diagrammatic cross-sectional view of a score line being formed in the label; and

FIG. 7 is a diagrammatic cross-section view, similar to that shown in FIG. 5b, illustrating an alternative label construction.

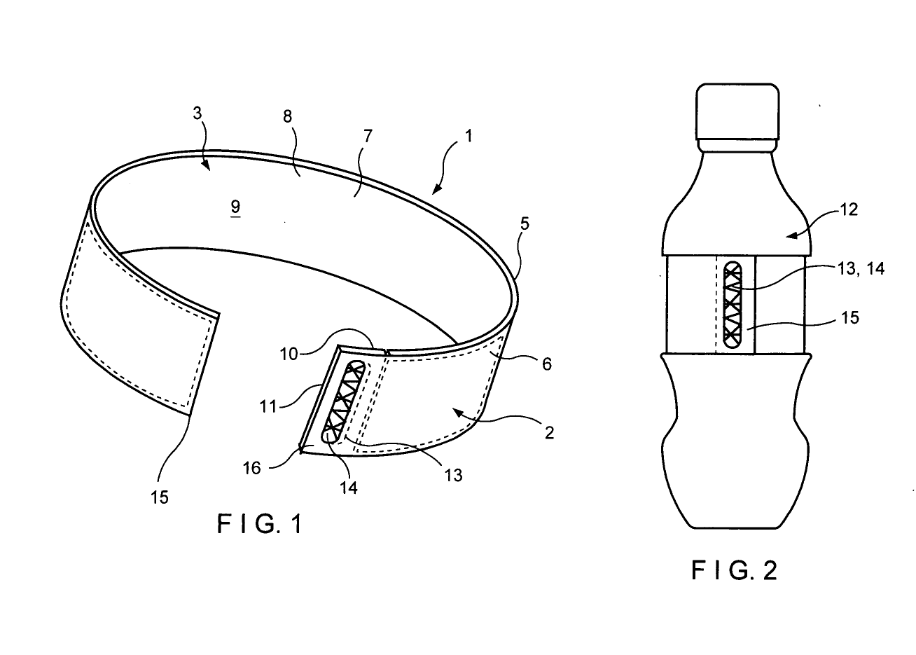

### DETAILED DESCRIPTION OF PREFERRED EMBODIMENTS

In the following, for the purposes of illustration, an embodiment of the invention is described with reference to specific materials for the first and second layers of the label. It will be appreciated however that other materials may be used in accordance with the underlying concept and spirit of the invention as described herein.

The label 1 includes a first major surface 2 which is arranged to present information such as, for example, a trade mark or advertising material, and a second major surface 3. The first major surface is formed by a first layer 5 of printed polyester, which is preferably coated with a clear polypropylene laminate 6 and the second major surface 3 is formed by a second layer 7 of polypropylene. The second layer 7 is divided into a removable portion 8, such as a sticker 9, and a tab 10 which comprises part of fastening means 11 for securing the label to an object such as a bottle 12, as shown in FIG. 2.

The label 1 is affixed to the bottle 12 by securing the fastening means 11 to the bottle with a suitable first aggressive adhesive 13. A second aggressive adhesive 14 may then be applied such that a second end 15 of the label may be wrapped around the bottle 12 and securely attached to a first end 16 of the label 1.

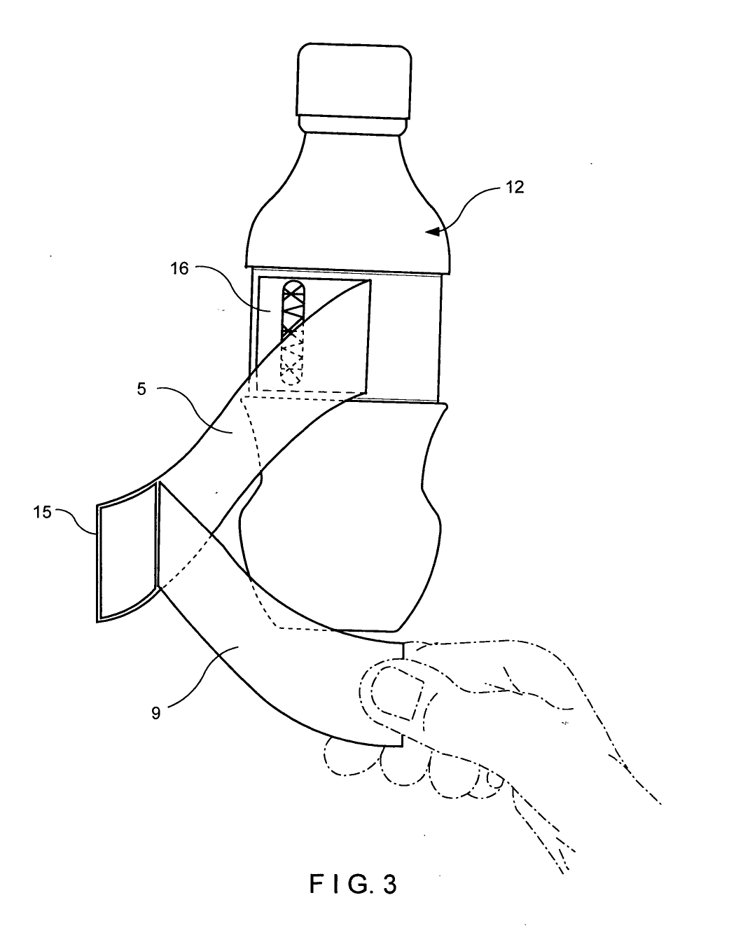

The second end 15 of the label 1 may then be freed by gripping the second end and peeling it away from the first end 16. The label may then be unwound from the bottle and the sticker 9 removed in the manner shown in FIG. 3. The fastening means ensures that the label 1 remains attached to the bottle 12.

As can be appreciated from the above, the invention provides a means of utilizing a second major surface of a label by attaching a removable sticker thereto. Further, removal of the sticker may be achieved without removing the rest of the label from the bottle so as to inhibit littering which may otherwise result if the label disengages from the bottle.

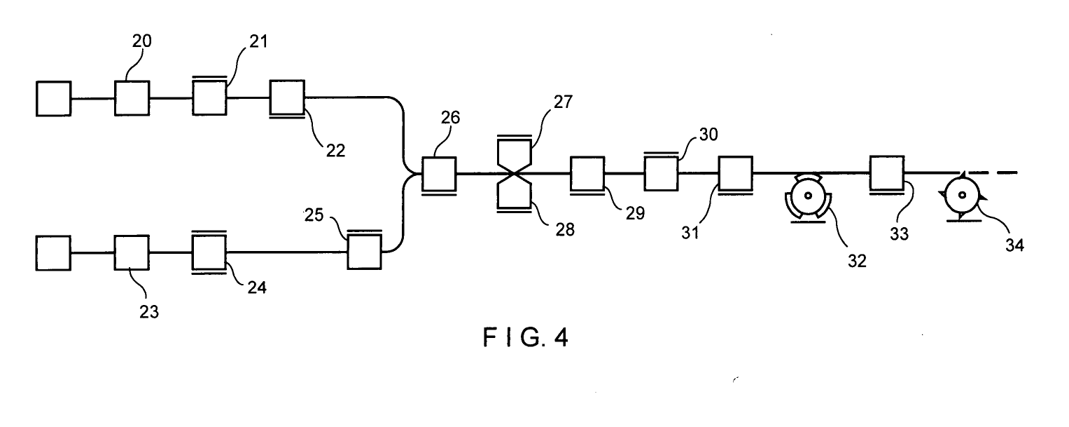

The construction of the label is more fully described with reference to FIG. 4.

The first layer 5 is produced by firstly forming a suitable polyester at step 20. The polyester is preferably a white polyester produced by combining PET (polyethylyne terepthalate) material with titaniumdioxide. The material is then chemically treated at step 21 for acceptance and penetration of ink, using a suitable combination of methylmethacrylate, butylacrylate, melamine resin and acrylic binder. Conventional plasma/Corona treatment was found not to provide adequate ink acceptance, with the result of deterioration and ink delamination from the polyester.

A release coating is applied at 22 on a side of the first layer which is to face the removable portion of the second layer. The release coating is preferably applied by way of a solvent based silicone treatment or a UV based coated silicon treatment in order to render the first layer with a silicon coating in the order of 0.5 to 3.0 grams/m², to provide a tight release of between 17 grams force/50 mm and 30 grams force/50 mm. Such a release strength factor achieves a significant advantage in that inadvertent release of the second layer from the first layer during labelling is prevented whilst still allowing the sticker portion 8 to be relatively easily removed by a purchaser of the bottle.

The second layer 7 is produced simultaneously with the first layer 5 and is formed of a material of less density than the first layer. The material is preferably polypropylene material which is formed at step 23, preferably as a white or opaque Biaxially Orientated Polypropylene (BOPP) which is then subjecting to a conventional Corona treatment 24 in order to lift a Dyne level of the material to within the range 33 to 73 for enhanced print adhesion.

A side of the second layer facing toward the first layer is coated with an adhesive at step 25. The adhesive is preferably an acrylic emulsion adhesive or a solvent based adhesive, suitable for effective operating temperatures of between −16° C. and 78° C. The adhesive is applied either by way of a roller or suitable spray system, to achieve a range of 9 to 25 grams/m².

The first and second layers are each produced separately in a continuous strip form and are secured together at step 26, whereby the adhesive applied to the second layer at step 25 is removably attached to the release coating of the first layer, applied at step 22. The “burst strength” of the combined layers was found to be in the order of 20 to 28 kg/mm².

At step 27, a printing process is applied to form printed information, artwork or the like for display at the first major surface, facing outwardly of the bottle to which the label is attached to.

Simultaneously, a printing process 28 is applied to provide the artwork to the sticker 9 whilst also rendering an eye mark on the second layer, followed by application of a slip varnish which is applied over the artwork at step 29. A clear polypropylene protective laminate may then be applied at step 30 on the outward facing side of the first layer.

The combined layers are then passed under an electronic eye at step 31 which detects the eye mark and actuates a rotary cutter at 32 to score a line in the second layer which defines the removable portion of the label. A second electronic eye 33 activates another rotary cutter at 34 to separate the strip of combined layers into individual labels which are then passed about a vacuum roller (not shown) for application of aggressive adhesive and attachment to a respective bottle.

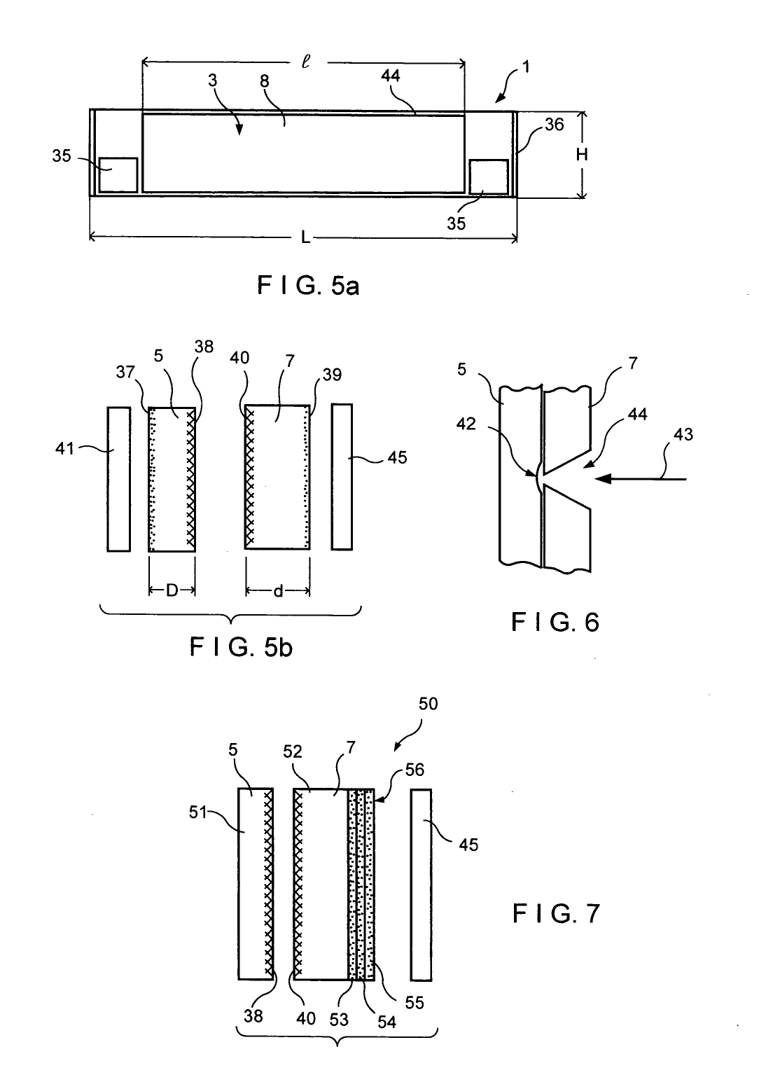

A more detailed example of the appearance of the second major surface 3 of a label 1, constructed in the above manner is shown in FIG. 5a. The label may be of any suitable dimensions. As an example, the label may be adapted to fit to a conventional 600 ml bottle produced by, for example, Coca-Cola and has an overall length dimension “L” of 235 mm and a height dimension “H” in the order of 45 mm. A label for a larger volume bottle, such as a 2.251 or 2.51 bottle produced for example by Pepsi, would typically have an overall length dimension “L” of 331 mm and a height dimension “H” of 135 mm. The removable sticker portion 8 may have a length “1” in the order of 175 mm in order to provide 30 mm long scanning regions 35 at either end of the label, to allow for reliable detection of an eye mark 36, which facilitates actuation of the rotary cutters at steps 32 and 34.

Referring now to the diagrammatic exploded cross section of FIG. 5b, the depth dimension “D” of the first layer 5, including print 37 and release coating 38 is in the range of about 12 micron to 36 micron. The second layer 7, including print 39 and adhesive 40, has a depth dimension “d” in the range of about 23 micron to 40 micron. This compares favourably with a conventional bottle label which has an overall depth dimension in the range 40 to 46 microns, allowing for addition of the clear polypropylene overlaminate 41, in the order of 12 micron.

As may be appreciated, the relative density and strength of the polyester created allows the overall thickness of the label 1 to be minimised so as to be comparable to that of a conventional label. The relative density of the polyester also provides an advantage that the polypropylene of the second layer 7 may be readily scored without cutting through the first layer. This is illustrated diagrammatically in FIG. 6 where a region 42 of the polyester layer 5 resists a force generated by a cutting action, indicated by arrow 43, which serves to cut through the relatively soft polypropylene to produce a score 44 in the second layer 7. Such a score is represented by line 44 in FIG. 5a, for defining the removable portion 8. As such, the second layer may be readily scored by the rotary cutter at step 32, as represented in FIG. 4, without severing or perforating the label as a whole. Accordingly, the label may still reliably be fed through a conventional bottling installation.

In addition to the above label composition, it may also be necessary to apply the slip varnish 45 to reduce the co-efficient of friction (C.O.F.) of the label to that available with conventional labels, in order that the label 1 runs smoothly through a labelling installation. More specifically, at present, bottle labels may be impregnated with “dust” on a rear surface, at a mill stage so that whilst travelling along the path of a labeller, at certain points, the material slips into predetermined positions, such as during application to a bottle. In particular, after individual labels are cut using electronic eye technology the individual labels are applied to a vacuum drum and allowed to “slip” around the vacuum drum until a bottle travels past.

The degree of slip is critical to allow correct timing for application of the labels and is determined by the C.O.F. of the label.

The label of the present invention does not have the “dust” impregnated in the second major surface, as this would interfere with application of the print 39. Accordingly, the label needs an additional slip varnish 45 to provide C.O.F. characteristics similar to a convention label.

A suitable varnish was formed utilizing the following components:

LABELSTAR™ 2540 Varnish 11132144 is a slip varnish (C.O.F.) Modified STARPAC™ AS3 Varnish 11006151. This was achieved by an addition of 1.2% of polyolefin wax to STARPAC™ AS3 Varnish 11006151.

Synthetic Silicone alternate. 0.1%

Glassene Silicone alternate 0.99%

Plasticiser Agent 0.5%

Polyester Waxing Agent 1.23%±0.3%

Emulsifier 2.0%+0.6%

The overall C.O.F. of the slip varnish may be varied by modifying the combinations of both natural waxes and synthetic silicones so that a minimum range of 0.25 C.O.F. and a maximum range of 0.40 may both be achieved, as required.

FIG. 7 illustrates an alternative label construction. The label 50 is formed in a generally similar manner to the label 1 and like parts are denoted with like reference numerals. In particular, the label 50 includes first and second layers 5,7 with a respective release coating 38 and adhesive 40, and slip varnish 45. The layers 5,7 are, however, formed of transparent material 51,52 preferably clear polyester and polypropylene, respectively. Instead of having a single layer of print 39, formed on the second layer 7, a plurality of overlaid print layers 53, 54 and 55 are instead formed on one side 56 of the second layer 7. The print layers comprise a first layer 53 printed directly onto the material 52 as a ‘reverse’ image for display toward the first major surface of the label, a masking layer 54 and a final layer 55 forming a second image facing outwardly of the second major surface of the label. Each of the print layers 53,55 may of course in turn comprise a number of different ink layers required to form each of the images.

Such an arrangement of print layers simplifies the production process of FIG. 4 to some extent since all of the printing procedures may be effected from one side only of the label and the need for a protective overlaminate 41, applied at step 30, may be dispensed with.

It is, however, a further possibility that the print layers 53, 54, 55 may be used in combination with a printed or opaque polyester layer 5 such that the image of print layer 53 may be obscured prior to removal of the portion 8. For that purpose, the polyester layer may perhaps be metallized. Such an arrangement may have application to a competition or a game where an image associated with a prize or the like needs to initially be hidden. Otherwise, the release strength factor between the first layer and removable portion 8, the relative density of the layers, to allow for appropriate scoring, and the coefficient of friction characteristics are the same as for the label 1.

The invention has been described by way of non-limiting example only, and many modifications or variations may be made thereto without departing from the spirit or the scope of the composite label as described.

I claim:

1. A composite label comprising a first layer adapted to display an image at a first major surface of the label and a second layer adapted to display an image at a second major surface of the label, the second layer including a removable portion adapted to be removed from the label and secured to another object, and wherein the first and second layers are formed of materials that are selected such that the second layer may be cut or scored so as to define the removable portion, without compromising the integrity of the first layer.

2. A composite label as claimed in claim 1, wherein the first layer is printed with the image to be displayed at the first major surface and the second layer is printed with the image to be displayed at the second major surface of the label.

3. A composite label as claimed in claim 1, wherein the material from which the first layer is formed has greater hardness than the material from which the second layer is formed.

4. A composite label as claimed in claim 1, wherein the first layer is a composite layer of two or more different materials.

5. A composite label as claimed in claim 1, wherein the first and second layers are formed of a material that is printable or which may be treated to render the material printable.

6. A composite label as claimed in claim 1, wherein at least one of the first and second layers comprises an ink receptive coating.

7. A composite label as claimed in claim 1, further comprising an adhesive provided on the second layer in order to enable the removable portion of the label to be removed and secured to another object.

8. A composite label as claimed in claim 7, further comprising a release coating provided on the first layer in order to facilitate removal of the removable portion of the label.

9. A composite as claimed in claim 8, wherein the release strength required to remove the removable portion form the label is from 17 grams force/50 mm to 30 grams force/50 mm.

10. A composite label as claimed in claim 1 wherein the composite label has a total thickness of from 50 to 150 μm.

11. A composite label as claimed in claim 1, wherein the first and second layers are independently formed from a material selected from the group consisting of polyolefins, polyesters, nylons and vinylidene polymers.

12. A composite as claimed in claim 1, wherein the first layer is formed from high density polypropylene having a density of about 0.8 to about 1.2 g/cm³ and the second layer is formed from a biaxially oriented polypropylene having a density of from 0.7 to 0.9 g/cm³.

13. A composite as claimed in claim 1, wherein the first layer is formed from polyethylene terephthalate and the second layer is formed from a biaxially oriented polypropylene.

14. A composite label comprising a first layer of printed polyester for displaying information at a first major surface of the label and a second layer including material having a density less than the polyester for presenting information at a second major surface of the label, the second layer including a removable portion arranged to be separated from the label and secured to another object.

15. A composite label as claimed in claim 14, wherein the material of the second layer comprises polypropylene.

16. A composite label as claimed in claim 14, wherein the second layer includes an adhesive on one side thereof for securing the removable portion to the first layer and the first layer includes a release coating to facilitate removal of the portion therefrom, the adhesive and release coating providing a release strength factor between 17 grams force/50 mm and 30 grams force/50 mm.

17. A composite label comprising a first layer for displaying information at a first major surface of the label and a second layer including a removable portion arranged to be separated from the label and secured to another object, wherein the second layer includes an adhesive on one side thereof for securing the removable portion to the first layer and the first layer includes a release coating to facilitate removal of the portion therefrom, the adhesive and release coating providing a release strength factor of between 17 grams force/50 mm and 30 grams force/50 mm.

18. A composite label as claimed in claim 17, wherein the first layer is formed of polyester and the second layer includes material having a density less than the polyester.

19. A composite label as claimed in claim 17, wherein the second layer is printed with information for display to both sides thereof.

20. A composite label as claimed in claim 19, wherein the first layer is transparent such that the information printed on the second layer is viewable from the first major surface of the label.

21. A composite label as claimed in claim 19, wherein the second layer includes a transparent material with a plurality of overlaid print layers applied thereto comprising a first image printed on the transparent material, for display toward the first major surface, a masking layer and a second image facing outwardly of the second major surface.

22. A composite label as claimed in claim 21, wherein the transparent material of the second layer comprises clear polypropylene.

23. A composite label as claimed in claim 14, wherein a clear polypropylene laminate is applied on the first major surface.

24. A composite label as claimed in claim 14, wherein a varnish is applied to the second major surface to provide the second major surface with a coefficient of friction in the range of about 0.25 to 0.40.

25. A composite label as claimed in claim 14, wherein the polyester is white.

26. A composite label as claimed in claim 14, wherein the polyester is metallized.

27. A composite label as claimed in claim 14, wherein a depth dimension of the first layer is in the range of about 12 micron to 30 micron.

28. A composite label as claimed in claim 27, wherein the second layer has a depth dimension in the range of about 23 micron to 40 micron.

29. A composition label as claimed in claim 14, wherein the second layer includes a mark for detection by an electronic eye to facilitate actuation of a cutting device, for scoring the second layer so as to define the removable portion.

30. A composite label as claimed in claim 29, wherein the removable portion is in the form of a sticker.

31. A composite label as claimed in claim 1 for use with a bottle, the label comprising an aggressive adhesive applied to the second major surface in a region adjacent the removable portion, to facilitate secure attachment of the label to the bottle.

32. A composite label comprising a first layer of printed polyester for displaying information at a first major surface of the label and a second layer for presenting information at a second major surface of the label, the second layer comprising a removable portion arranged to be separated from the label and secured to another object, and wherein the second layer is formed of a material having a density and softness less than the polyester, to allow the second layer to be cut or scored so as to define the removable portion, without compromising the integrity of the first layer.

33. A composite label as claimed in claim 32, wherein the material of the second layer comprises polypropylene.

34. A composite label comprising a first layer for displaying information at a first major surface of the label, and a second layer comprising a removable portion arranged so as to be separated from the label and secured to another object, wherein the second layer includes an adhesive on one side thereof for securing the removable portion to the first layer and the first layer includes a release coating to facilitate removal of the portion therefrom, the adhesive and release coating providing a release strength factor of between 17 grams force/50 mm and 30 grams force/50 mm, and wherein the first layer is formed of polyester and the second layer includes material having a softness less than the polyester, the allow the second layer to be cut or scored so as to define the removable portion, without compromising the integrity of the first layer.

35. A composite label as claimed in claim 34, wherein the second layer is printed with information for display to both sides thereof.

36. A composite label as claimed in claim 35, wherein the first layer is transparent such that the information printed on the second layer is viewable from the first major surface of the label.

37. A composite label as claimed in claim 35, wherein the second layer comprises a transparent material with a plurality of overlaid print layers applied thereto comprising a first image printed on the transparent material, for display toward the first major surface, a masking layer and a second image facing outwardly of the second major surface.

38. A composite label as claimed in claim 37, wherein the transparent material of the second layer comprises clear polypropylene.

39. A composite label as claimed in claim 32, wherein a clear polypropylene laminate is applied on the first major surface.

40. A composite label as claimed in claim 32, wherein a varnish is applied to the second major surface to provide the second major surface with a coefficient of friction in the range of about 0.25 to 0.40.

41. A composite label as claimed in claim 32, wherein the polyester is white.

42. A composite label a claimed in claim 32, wherein the polyester is metallized.

43. A composite label as claimed in claim 32, wherein a depth dimension of the first layer is in the range of about 12 micron to 30 micron.

44. A composite label as claimed in claim 43, wherein the second layer has a depth dimension in the range of about 23 micron to 40 micron.

45. A composite label as claimed in claim 32, wherein the second layer comprises a mark for detection by an electronic eye to facilitate actuation of a cutting device, for scoring the second layer so as to define the removable portion.

46. A composite label as claimed in claim 45, wherein the removable portion is in the form of a sticker.

47. A composite label as claimed in claim 45 for use with a bottle, the label further comprising an aggressive adhesive applied to the second major surface in a region adjacent the removable portion, to facilitate secure attachment of the label to the bottle.
